(19) United States
(12) Patent Application Publication
(10) Pub. No.: US 2018/0288092 A1
(43) Pub. Date: Oct. 4, 2018

(54) PROTECTION FROM RELAY ATTACKS IN WIRELESS COMMUNICATION SYSTEMS

(71) Applicant: QUALCOMM Incorporated, San Diego, CA (US)

(72) Inventors: Joel Benjamin LINSKY, San Diego, CA (US); Robin HEYDON, Cambridge (GB)

(21) Appl. No.: 15/473,604

(22) Filed: Mar. 30, 2017

(51) Int. Cl. H04L 29/06; H04W 12/12; H04L 9/08; H04L 9/06

(52) U.S. Cl. CPC H04L 63/1466; H04L 9/0631; H04L 9/0869; H04W 12/12

(57) ABSTRACT

Systems and methods related to a wireless communication system include detection of and protection from relay-in-the-middle attacks. A first wireless device receives a data packet transmitted by a second wireless device and determines whether the data packet includes a jitter introduced by the second wireless device based on a function of a shared key between the first wireless device and the second wireless device. The first wireless device determines whether a relay-in-the-middle attack is present between the first wireless device and the second wireless device based on whether the data packet includes the jitter. The first wireless device may withhold transmission of sensitive messages based on a determination that the relay-in-the-middle attack is present.

### FIELD OF DISCLOSURE

Disclosed aspects are directed to wireless communication systems. More specifically, exemplary aspects of this disclosure relate to detection of and protection from relay attacks on a wireless communication device.

### BACKGROUND

With the proliferation of devices configured for wireless communication, notions of proximity between devices are seen to play an important role in aspects of wireless communication security. Two wireless communication devices may be configured for communication with one another by flexibly and sometimes interchangeably taking on roles of a controller device and a controlled or target device. For instance, a mobile phone may be configured as a controller device to wirelessly locate, communicate with, control, and operate a target device such as an Internet-of-Things (IoT) device using wireless communication technology such as WiFi, near-field communication (NFC), radio frequency (RF), Bluetooth, or the like. In some cases, a certain level of security in the communication between the controller device and the target device may be assumed if the two devices are within a predetermined proximity of one another.

To illustrate, consider a contactless (wireless) payment system in which a payment instrument, such as a contactless credit card or smart phone may be configured as a target device which interfaces with a payment card reader configured as a controller device. The payment card reader may be configured to read information from the contactless credit card when the contactless credit card is within a predetermined proximity (e.g., a few centimeters). There is an underlying assumption of security when the contactless credit card is within this predetermined proximity of the payment card reader, because it would be difficult for a third party device to intercept sensitive information transferred between the contactless credit card and the payment card reader when they are within this predetermined proximity of one another. In another example, a passive keyless entry system may similarly involve an assumption of proximity for the purpose of security: a vehicle, for example, can be opened when the remote key is within a predetermined proximity of the vehicle (e.g., a bounded distance of 1 meter).

However, attacks such as a relay-in-the-middle (RITM) or relay attacks are designed to compromise the assumptions of proximity in the systems described above in order to compromise security. A relay-in-the-middle attack builds on a traditional man-in-the-middle attack wherein an attacker may intercept and manipulate communications between the controller device and the target device. In a RITM attack, an attacker may simply relay messages between the target device and the controller device without manipulating the messages or even necessarily reading or parsing the messages. However, this relaying can compromise assumptions of proximity by tricking the target device into trusting that the relay device is the controller device, which allows the relay device to gain access to the target device simply by getting within the predetermined proximity of the target device to override proximity-based security. For example, in the passive keyless entry system a relay device can extend the range (i.e., create a fake assumption of proximity) between the remote key, which may be located inside a home or office and the vehicle, which may be parked in a parking lot at a distance much greater than the bounded distance of 1 meter. In this manner, an attacker may use the relay device to trick the vehicle's lock into thinking that the remote key is within the bounded distance, thus enabling the attacker to unlock the vehicle without being in possession of the remote key.

Accordingly, it is recognized that as attacks such as RITM attacks on wireless communication security become more sophisticated, there is a corresponding need to detect such attacks and protect the wireless communication devices from such attacks.

### SUMMARY

Exemplary aspects include systems and methods related to a wireless communication system for detection of and protection from a relay-in-the-middle attack. A first wireless device receives a data packet transmitted by a second wireless device and determines whether the data packet includes a jitter introduced by the second wireless device based on a function of a shared key between the first wireless device and the second wireless device. The first wireless device determines whether a relay-in-the-middle attack is present between the first wireless device and the second wireless device based on whether the data packet includes the jitter. The first wireless device may withhold transmission of sensitive messages based on a determination that the relay-in-the-middle attack is present. The data packet may be transmitted as a Bluetooth signal and the jitter may be greater than an expected uncertainty in an inter-frame space related to the data packet.

For example, an exemplary aspect is directed to a method of operating a wireless communication system. The method comprises receiving, at a first wireless device, a data packet transmitted by a second wireless device and determining, at the first wireless device, whether the data packet includes a jitter introduced by the second wireless device based on a function of a shared key between the first wireless device and the second wireless device. The method further includes determining whether a relay-in-the-middle attack is present between the first wireless device and the second wireless device based on whether the data packet includes the jitter.

Another exemplary aspect is directed to an apparatus such as a first wireless device which comprises a memory, a transceiver configured to receive a data packet transmitted by a second wireless device, and a processor coupled to the memory and the transceiver. The processor is configured to determine whether the data packet includes a jitter introduced by the second wireless device based on a function of a shared key between the first wireless device and the second wireless device, and determine whether a relay-in-the-middle attack is present between the first wireless device and the second wireless device based on whether the data packet includes the jitter.

Another exemplary aspect is directed to an apparatus such as a first wireless device comprising means for receiving a data packet transmitted by a second wireless device, means for determining whether the data packet includes a jitter introduced by the second wireless device based on a function of a shared key between the first wireless device and the second wireless device, and means for determining whether a relay-in-the-middle attack is present between the first wireless device and the second wireless device based on whether the data packet includes the jitter.

Yet another exemplary aspect is directed to a non-transitory computer-readable storage medium comprising code, which, when executed by a processor, causes the processor to perform operations for a wireless communication system. The non-transitory computer-readable storage medium comprises code for receiving, at a first wireless device, a data packet transmitted by a second wireless device; code for determining, at the first wireless device, whether the data packet includes a jitter introduced by the second wireless device based on a function of a shared key between the first wireless device and the second wireless device; and code for determining whether a relay-in-the-middle attack is present between the first wireless device and the second wireless device based on whether the data packet includes the jitter.

### BRIEF DESCRIPTION OF THE DRAWINGS

The accompanying drawings are presented to aid in the description of aspects of the invention and are provided solely for illustration of the aspects and not limitation thereof.

FIG. 1 illustrates a wireless communication system configured according to an aspect of this disclosure.

FIG. 2 illustrates an example implementation for generating a jitter cipher sequence according to an aspect of this disclosure.

FIG. 3 illustrates an example process of detecting and protecting against relay-in-the-middle attacks in a paired device model, according to an aspect of this disclosure.

FIG. 4 illustrates an example process of detecting and protecting against relay-in-the-middle attacks in an access server model, according to an aspect of this disclosure.

FIG. 5 illustrates an example process of detecting and protecting against relay-in-the-middle attacks, according to an aspect of this disclosure.

### DETAILED DESCRIPTION

Aspects of the invention are disclosed in the following description and related drawings directed to specific aspects of the invention. Alternative aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects are generally directed to protection of wireless communication devices from RITM attacks or relay attacks. For example, wireless communication between a first wireless device and a second wireless device is protected from relay attacks in an exemplary aspect. In an example approach for detecting relay attacks, the first and second wireless devices are pre-authenticated or provisioned with a shared key. Based on the shared key, one or more attributes of messages exchanged between the first and second wireless devices are altered as a function of the shared key. One or both of the first and second wireless devices will be able to validate whether messages received have their attributes altered in the expected manner An RITM attacker will be unable to intercept and forward the messages between the first and second wireless devices without failing the above-noted validation at the first wireless device and/or the second wireless device. In exemplary aspects, failing the validation is taken as an indication of an RITM attacker being present. Further, in some aspects, the validation may be performed prior to communication of sensitive information, and so if the validation fails, withholding the communication of sensitive information (e.g., while the RITM attack is present) may provide protection against the RITM attack. Additional security measures may also be implemented such as logging and/or reporting any potential RITM attacks, but these are beyond the scope of this disclosure and as such will not be dealt with exhaustively herein.

In one example which will be discussed in greater detail in the description of exemplary aspects, the attribute of the messages that is altered is a time between packets of information. However, in various other aspects it is possible to alter other attributes such as frequency of transmission, modulation parameters, etc., without deviating from the scope of this disclosure.

In the following description, a specific type of wireless communication related to Bluetooth® standards (including emerging technologies such as Bluetooth Low Energy (BLE)) will be used in the discussion of exemplary aspects. However, it will be understood that aspects of this disclosure are not limited to Bluetooth or BLE, but may be extended to other wireless communication protocols without departing from the scope of this disclosure. In an example where the first and second wireless devices are in communication based on a Bluetooth communication protocol, protection from relay attacks is provided based on altering a time attribute, such as introducing a jitter in a time between frames of Bluetooth packets transmitted (known as an inter-frame space or T_IFS) between the first wireless device and the second wireless device. The jitter may be based on a function of the shared key between the first and second wireless devices.

A relay attacker, if present, would incur a time delay in intercepting and forwarding the packets between the first and second wireless devices. This time delay incurred by the relay attacker would effectively destroy the relay attacker's ability to replicate the jitter because packets would be received with the time delay of the relay attacker introduced, which would no longer correspond to the T_IFS with the expected jitter. Thus, by validating that the jitter in the T_IFS of received packets matches the expected jitter, e.g., over the course of several packet exchanges, a relay attack can be detected. The first and second wireless devices can protect themselves from the relay attack by withholding transmission of sensitive information over the air, e.g., until the security threat from the relay attack is resolved (resolving the security threat may take many forms which may be beyond the scope of this disclosure, as noted above).

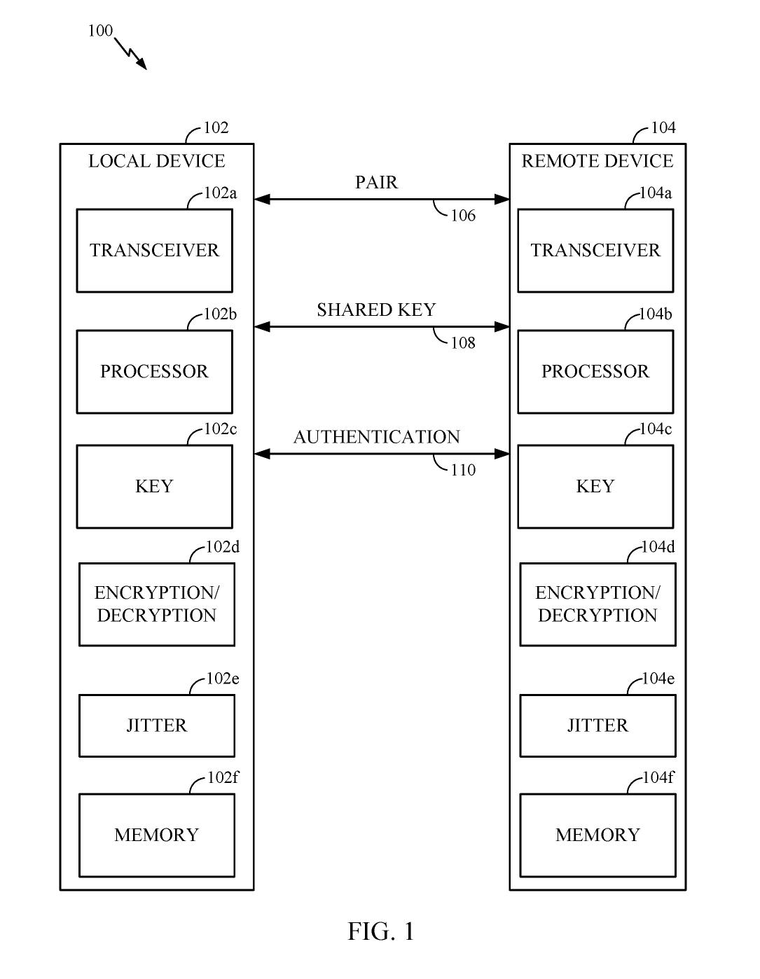

With reference now to FIG. 1 a schematic view of wireless communication system 100 is shown. Two example wireless devices are shown, a first wireless device referred to as local device 102 and a second wireless device referred to as remote device 104. The designations of “local” and “remote” are not meant to limit the devices to a specific functionality but are provided from the perspective of an example communication between the two devices. Thus, without any inherent limitations to the functionalities of either device, in the following examples, local device 102 may alternatively be referred to as a controller device, a host device, a master device, etc., and remote device 104 may alternatively be referred to as a target device, a slave device, etc.

Local device 102 and remote device 104 may be configured to communicate using one or more communication technologies including Bluetooth communication, which will be specifically discussed (it is noted that the term Bluetooth communication in this disclosure is meant to be inclusive of variations such as BLE standards). Local device 102 and remote device 104 may respectively include transceiver 102a and transceiver 104a configured for transmission and reception of wireless signals including Bluetooth signals. Local device 102 and remote device 104 may respectively include processor 102b and processor 104b configured for various processing functionalities of the respective devices. Processor 102b and processor 104b may represent one or more general purpose processors, digital signal processors, application specific processors, etc. Local device 102 and remote device 104 are also shown to respectively include memory 102f and memory 104f for storing information such as data and instructions.

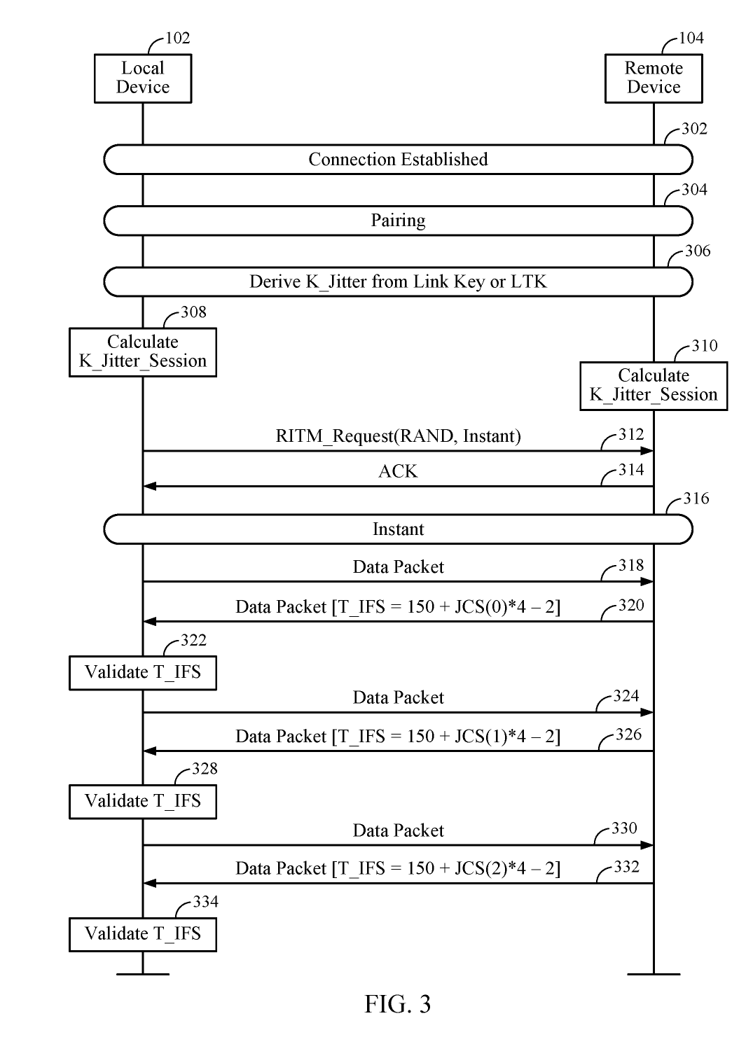

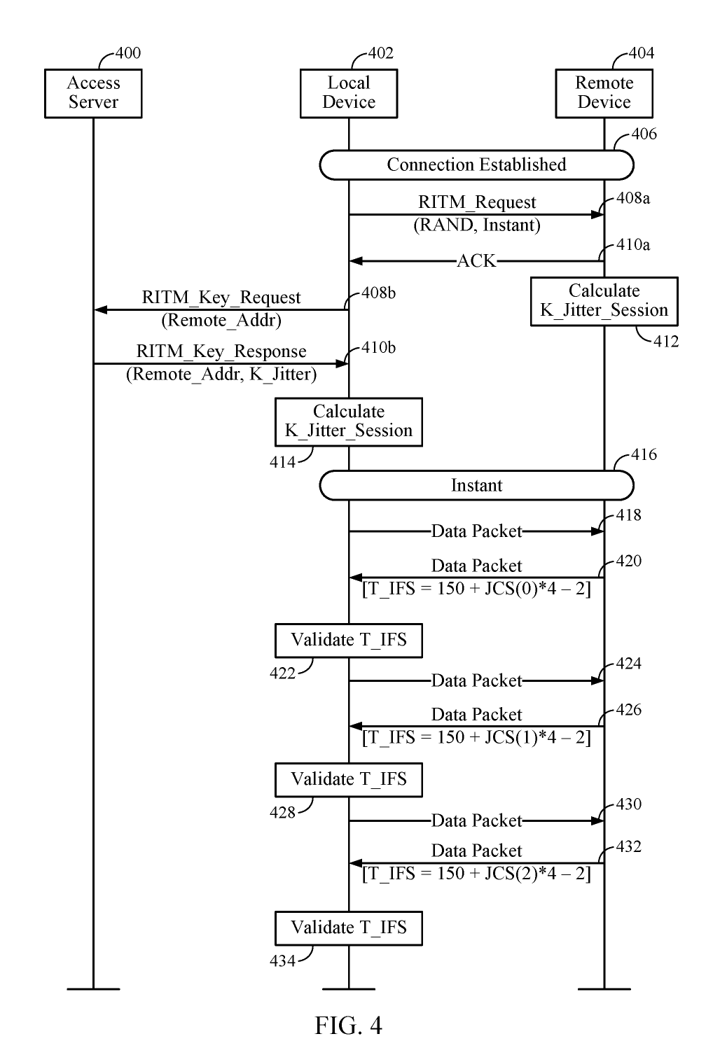

Local device 102 and remote device 104 may also respectively include key blocks 102c and 104c configured for managing and storing one or more root keys including at least one shared key between local device 102 and remote device 104. Further, local device 102 and remote device 104 may also respectively include encryption/decryption blocks 102d and 104d configured for encrypting/decrypting messages sent between local device 102 and remote device 104. In a process of pairing (designated by the reference numeral 106) local device 102 and remote device 104, one or more shared keys may be created between local device 102 and remote device 104. In a process of bonding (designated by the reference numeral 108) local device 102 and remote device 104, the one or more shared keys created may be stored in key blocks 102c and 104c for use in subsequent communication between local device 102 and remote device 104. Further, a process of authentication (designated by the reference numeral 110) may also be performed to verify that local device 102 and remote device 104 have shared keys during future communication once local device 102 and remote device 104 are paired and bonded. The authentication may involve a series of challenge and response sequences to establish that local device 102 and remote device 104 have the required shared keys. In exemplary aspects, authentication 110 may further involve validating that inter-frame space (T_IFS) of received packets have an expected jitter, as will be discussed in greater detail with reference to FIGS. 3-4.

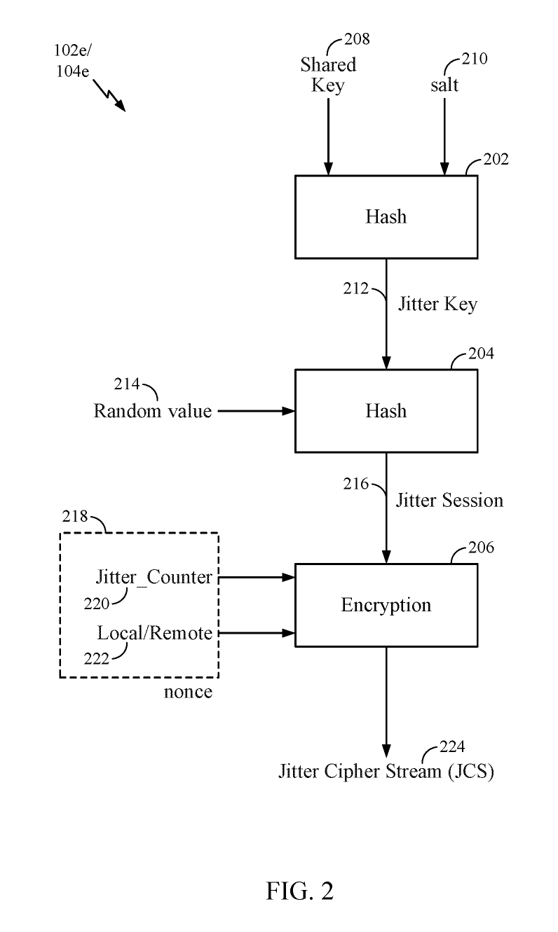

FIG. 1 also shows jitter management blocks 102e and 104e respectively provided in local device 102 and remote device 104 for calculation and validation of the jitter. Jitter management blocks 102e and 104e will be discussed further with reference to FIG. 2.

In FIG. 1, local device 102 and remote device 104 may be separated by a distance which can have an impact on the time taken for messages to travel between the two devices. The Bluetooth standard (specifically BLE) specifies an inter-frame space (T_IFS) between packets transmitted by a device to be 150 us, but allows a variation of +/−2 us to account for the distance between local device 102 and remote device 104. Thus, for the jitter which is introduced in exemplary aspects to be noticeable in order to enable detection of potential RITM attackers, the T_IFS is skewed (i.e., packets with less or more inter-frame space between them) to an amount greater than the variation of +/−2 us allowed in the specification.

In an example, a sequence, referred to as a jitter cipher sequence (JCS) is generated at each of local device 102 and remote device 104. The JCS sequence can comprise a series of bits, wherein a “1” can mean a positive value and a “0” can mean a negative value. In a gradual disclosure approach, the bits of the JCS are applied successively to a series of messages (e.g., as part of authentication 110) transmitted between local device 102 and remote device 104. The messages are validated to check whether they have the expected jitter. In one example, a first bit of the JCS is multiplied by a constant factor such as 4 for a first sequence of messages, a second bit of the JCS is multiplied by the same constant factor for a second sequence of messages, and so on. For each sequence, this can be represented in units of microseconds (us) as T_IFS=150+JCS(i)*4−2. Thus, for each sequence, T_IFS would range from 150−6=144 (i.e. in the case wherein JCS(i) is “0” and treated as −1) to 150+2=152 (i.e., in the case wherein JCS(i) is “1” and treated as +1). As the number of sequences validated in this manner increases, the possibility that a relay attack can go undetected shrinks. After a number, e.g., a sequence of 20 messages are validated with T_IFS jittered based on respective 20 bits of the JCS, the possibility of a relay attack going undetected is miniscule, e.g., of the order of a one in a million chance.

With combined references now to FIGS. 1-2, an example process by which local device 102 and remote device 104 generate the jitter cipher sequence (JCS) is illustrated. The process of FIG. 2 may be implemented by jitter management block 102e of local device 102 and jitter management block 104e of remote device 104 in one example.

Accordingly, in one aspect, subsequent to pairing (106) of local device 102 and remote device 104, a shared key is generated as previously explained. It is noted that pairing the devices to generate a shared key is applicable to a paired device model explained further with reference to FIG. 3. An alternative model in which local device 102 and remote device 104 may obtain a shared key may be through advance provisioning of a shared key by an access server, such as in an access server model which will be discussed further with reference to FIG. 4.

With continuing reference to FIG. 2, the shared key is shown with the reference numeral 208 (the shared key may also be referred to using other terms known in the art, such as a link key or long term key “LTK”). Shared key 208 is one input to a first hash block 202. Another input may be a “salt” shown with reference numeral 210, wherein, in the field of cryptography, a salt will be recognized as a random data that is used as an additional input to a one-way function that generally hashes a password, for example. In this case, salt 210 is hashed with shared key 208. A new salt 210 may be generated for each shared key 208.

Hash block 202 may be implemented as a hash-based message authentication code (HMAC). In a specific example, a HMAC secure hash algorithm (SHA) of 256 bits, or “HMAC-SHA-256.” As a result of shared key 208 hashed with salt 210 in the first hash block 202, jitter key 212 is generated as an output for further processing. In some cases, it is also possible to provide a jitter key such as jitter key 212 in advance to the devices, e.g., in another implementation of an access server model.

Regardless of how jitter key 212 is generated, continuing with the process of FIG. 2, a random value known as “RAND” in the context of cryptography and designated by the reference numeral 214 is generated (e.g., by processor 102b) and provided as an input to a second hash block 204. Second hash block 204 may hash random value 214 with jitter key 212 to generate a jitter key for each session (i.e., each time a new connection is established between local device 102 and remote device 104), shown as jitter session 216. In some examples, second hash block 204 may implement a secure hash algorithm (SHA) of 256 bits or SHA-256 in hashing random value 214 with jitter key 212 to create jitter session 216.

With continuing reference to FIG. 2, nonce 218 will now be explained. In cryptography, a nonce is an arbitrary number that may only be used once. Nonce 218 is similar to salt 210 in this regard. Nonce 218 may be a random or pseudo-random number issued in an authentication protocol to ensure that old communications cannot be reused in replay attacks. As shown in FIG. 2, nonce 218 may be generated using a combination of jitter counter 220 and local/remote bit 222. Jitter counter 220 is a counter which is updated (e.g., incremented) after a predetermined number of messages are exchanged, e.g., after 128 connection events where messages are exchanged between paired devices 102 and 104. Local/remote bit 222 maintains an indication of whether the jitter cipher sequence is being created for transmission by local device 102 or remote device 104 (in this case, it will be set, e.g., to “1” to indicate that the jitter cipher sequence is being created for transmission by local device 102).

In a final step, encryption block 206 uses nonce 218 or separately receives the components jitter counter 220 and local/remote bit 222 as shown, as well as jitter session 216 to encrypt the combination of these inputs (e.g., using an encryption mechanism such as Advanced Encryption Standard (AES) of 128-bits or AES-128) to generate jitter cipher sequence (JCS) 224. It is noted that the example of jitter counter 220 being set to a value of 128 may correspond to the AES-128 which generates JCS 224 of 128-bits. Once all 128 bits of JCS 224 have been used for jittering T_IFS in a corresponding sequence of messages, a new set of bits for JCS 224 can be generated by resetting jitter counter 220.

With reference now to FIG. 3 (as well as with combined reference to FIGS. 1-2), an example process flow for detecting whether there is a relay attack between local device 102 and remote device 104 in a paired device model will be explained. As previously mentioned, in the paired device model, the two devices are paired in advance which results in a shared key (e.g., shared key 208 of FIG. 2). The paired device model may be used for devices which have a small number of device combinations, e.g., the aforementioned vehicle/lock in the role of a remote device and a key fob in the role of a local device.

With continuing reference to FIG. 3, in Step 302, a wireless connection such as a Bluetooth connection is established between local device 102 and remote device 104, following which the two devices are paired in Step 304 (similar to pairing 106 described in FIG. 1) which leads to establishment of shared key 208 at local device 102 and remote device 104. In Step 306, the process of determining jitter key 212 is performed at respective jitter management blocks 102e and 104e of local device 102 and remote device 104, as described in FIG. 2. In Step 308, jitter session 216 is calculated at local device 102 for an example session of transmitting packets initiated by local device 102. In Step 310, jitter session 216 is calculated at remote device 104 when packets transmitted from local device 102 are received.

Starting with message 312 transmitted from local device 102 to remote device 104, a sequence of actions for determining whether there is a relay attack may commence and these sequence of messages starting from message 312 may be part of authentication 110 shown in FIG. 1. In the illustrated example, in each sequence, a data packet is sent from local device 102 to remote device 104 without an added jitter, and the data packet is returned from remote device 104 to local device 102 with a corresponding jitter added for that sequence. Local device 102 validates whether the jitter added in the data packet received from remote device 104 matches an expected value.

Accordingly, message 312 may include a message to remote device 104 that a check for potential RITM devices will be performed, along with a random number and time instant used in the generation of JCS 224 at each of local device 102 and remote device 104, which is acknowledged by message 314 from remote device 104. Instant 316 may represent the calculations involved in generation of JCS 224 (e.g., at respective blocks 102e and 104e of local device 102 and remote device 104).

In a first sequence of message exchanges, message 318 comprises a data packet transmitted from local device 102 to remote device 104, and message 320 comprises the data packet returned from remote device 104 to local device 102 with a jitter introduced in the inter-frame space between the data packets based on a first bit of JCS 224. At Step 322, local device 102 validates whether the T_IFS in the data packet returned in message 320 has a jitter which matches the expected jitter based on the first bit of JCS 224. For instance, in local device 102, processor 102b may receive information such as the T_IFS of the received data packet from transceiver 102a and information about an expected jitter from jitter management block 102e or from a stored value thereof in memory 102f, and processor 102 may include processing elements (not shown) configured to determine whether the T_IFS matches the expected jitter based on the first bit of JCS 224, and if it does not match, provide an indication (e.g., set a flag) that a RITM attack may be present.

The above process is repeated for two more sequences shown in FIG. 3, with a second sequence of messages comprising message 324 with a data packet to remote device 104, message 326 comprising the data packet returned with a jitter in the T_IFS based on a second bit of JCS 224 and Step 328 comprising validation of the expected jitter in message 326 based on the second bit of JCS 224; and a third sequence of messages comprising message 330 with a data packet to remote device 104, message 332 comprising the data packet returned with a jitter in the T_IFS based on a third bit of JCS 224 and Step 334 comprising validation of the expected jitter in message 332 based on the third bit of JCS 224. The validation in Steps 328 and 334 may be performed in a similar manner as discussed above for Step 322.

If the validation in Steps 322, 328, and 334 are successful, in the example shown, the process can finish and it may be determined that there are no relay attacks between local device 102 and remote device 104. In some cases, the process can continue with sequences following the third sequence until a predetermined number of sequences are validated. Following the validation, communication of sensitive information can proceed. For example, if remote device 104 is a target device such as a vehicle lock and local device 102 is a controller device such as a remote key fob, the vehicle lock may accept a command to unlock the vehicle once the sequence of validation is completed; otherwise, the vehicle lock may not unlock.

With reference now to FIG. 4, the above-described aspects of detecting and protecting from relay attacks are shown for the case of local device 102 and remote device 104 provisioned in an access server model. Rather than the paired connection model where the two devices establish a shared key through a process of pairing, in the access server model, they are provisioned with a key through a common access server. An access server, for example, may be a system which provides a common key to both a controller device such as a door lock or payment card reader and a target device such as a tag or a contactless credit card from the previously described examples. From the below description, it will be seen that the process of validation of a sequence of messages will be similar to that described with reference to FIG. 3, with some differences in the initial processes related to establishing the shared key.

Accordingly, in FIG. 4, access server 400 is shown along with local device 402 and remote device 404 as previously described. At Step 406, a connection is established between local device 402 and remote device 404. At Step 408a, local device 402 initiates an RITM request to remote device 404 and receives a corresponding response at Step 410a from remote device 404. Local device 402 also sends a key request to access server 400 at Step 408b and receives a key at Step 410b. This received key acts as the shared key, which is provisioned by access server 400 to local device 402 and remote device 404. Using this shared key, jitter session keys are calculated in Step 414 at local device 402 and in Step 412 at remote device 404 based on the received key from access server 400. Following this step, the processes are similar to those described with counterpart reference numerals in FIG. 3.

Instant 416 may represent the calculations involved in generation of a jitter cipher sequence (JCS) such as JCS 224. In a first sequence of message exchanges, message 418 comprises a data packet transmitted from local device 402 to remote device 404, and message 420 comprises the data packet returned from remote device 404 to local device 402 with a jitter introduced in the inter-frame space between the data packets based on a first bit of the JCS. At Step 422, local device 402 validates whether the T_IFS in the data packet returned in message 420 has a jitter which matches the expected jitter based on the first bit of the JCS (e.g., local device 402 may include similar functionality as discussed with reference to local device 102 for performing such validation).

The above process is repeated for two more sequences shown in FIG. 4, with a second sequence of messages comprising message 424 with a data packet to remote device 404, message 426 comprising the data packet returned with a jitter in the T_IFS based on a second bit of the JCS and Step 428 comprising validation of the expected jitter in message 426 based on the second bit of the JCS; and a third sequence of messages comprising message 430 with a data packet to remote device 404, message 432 comprising the data packet returned with a jitter in the T_IFS based on a third bit of the JCS and Step 434 comprising validation of the expected jitter in message 432 based on the third bit of the JCS.

If the validation in steps 422, 428, and 434 are successful, in the example shown, the process can finish and it may be determined that there are no relay attacks between local device 402 and remote device 404. In some cases, the process can continue with sequences following the third sequence until a predetermined number of sequences are validated. Following the validation, communication of sensitive information can proceed. For example, if remote device 404 is a target device such as a contactless credit card and local device 402 is a controller device such as a payment card reader, the contactless credit card may accept a command to transfer sensitive information to the payment card reader once the sequence of validation is completed; otherwise, the contactless credit card may not transmit the sensitive information such as a credit card number or other personal finance data of a user.

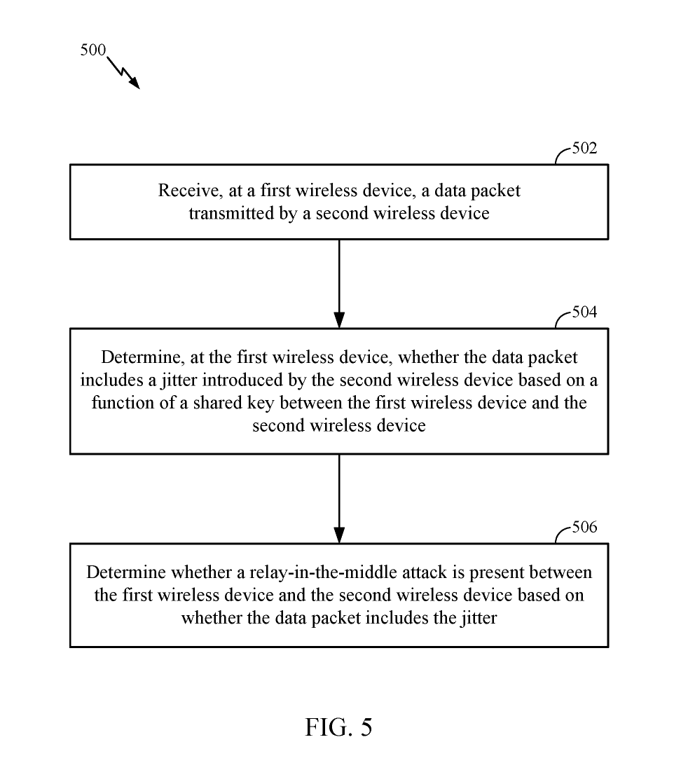

It will be appreciated that exemplary aspects include various methods for performing the processes, functions and/or algorithms disclosed herein. For example, as illustrated in FIG. 5, an exemplary aspect can include a method (500) of operating a wireless communication system (e.g., wireless communication system 100 of FIG. 1).

Block 502 comprises receiving, at a first wireless device, a data packet transmitted by a second wireless device (e.g., receiving the data packet in message 320 at local device 102 from remote device 104 in FIG. 3).

Block 504 comprises determining, at the first wireless device, whether the data packet includes a jitter introduced by the second wireless device based on a function of a shared key between the first wireless device and the second wireless device (e.g., Step 322 of FIG. 3 for validating whether the jitter in the data packet of message 320 matches an expected jitter calculated in jitter block 102e of local device 102 using the implementation shown in FIG. 2).

Block 506 comprises determining whether a relay-in-the-middle attack is present between the first wireless device and the second wireless device based on whether the data packet includes the jitter (e.g., determining that there is a relay-in-the-middle attack if the validation fails in any one or more of Steps 322, 328, 334 of FIG. 3).

In further aspects, method 500 may also include protecting from the relay-in-the-middle attack by withholding transmission of sensitive messages based on a determination that the relay-in-the-middle attack is present. For example, local device 102 may withhold (e.g., processor 102b may cause to be withheld, by directing transceiver 102a) transmission of further data packets if the validation fails at any one or more of Steps 322, 328, 334 of FIG. 3.

In accordance with aspects discussed in FIG. 3, method 500 may be compatible in situations wherein the first wireless device is configured in a paired device model for wireless communication with the second wireless device, and wherein the shared key is established between the first wireless device and the second wireless device during a process of pairing the first wireless device and the second wireless device (e.g., during Step 304 of FIG. 3 or pairing 106 described in FIG. 1).

Alternatively, in accordance with aspects discussed in FIG. 4, method 500 may be compatible in situations wherein the first wireless device is configured in an access server model for wireless communication with the second wireless device, and wherein the shared key is provisioned by an access server to the first wireless device and the second wireless device (e.g., during Steps 408a-b and 410a-b of FIG. 4).

In either one of the two models (i.e., paired device model of FIG. 3 or access server model of FIG. 4), method 500 may further include generating a jitter cipher sequence comprising the jitter and one or more additional jitters based on the function of the shared key. For instance, method 500 may further include processes associated with generation of the jitter cipher sequence (JCS) using jitter management block 102e of local device 102 and jitter management block 104e of remote device 104 as discussed with reference to FIG. 2 above. More specifically, an exemplary process in this regard may include determining a jitter key from a first hash of the shared key and a salt (e.g., generating jitter key 212 in first hash block 202 using shared key 208 and salt 210); determining a jitter session key from a second hash of the jitter key and a random value (e.g., generating jitter session 216 in second hash block 204 using jitter key 212 and random value 204); and generating the jitter cipher sequence based on an encryption of at least the jitter session key and a jitter counter (e.g., generating jitter cipher sequence 224 in encryption block 206 using at least jitter session 216 and jitter counter 220).

Accordingly, based on the above-described techniques method 500 can include determining, at the first wireless device, if two or more data packets received from the second wireless device include two or more jitters, the two or more jitters based on two or more bits of the jitter cipher sequence (e.g., based on JCS bits JCS(0), JCS(1), JCS(2), etc. received at local device 102 from remote device 104 at Steps 320, 326, 332, respectively of FIG. 3); and determining whether the relay-in-the-middle attack is present between the first wireless device and the second wireless device based further on whether the two or more data packets include the two or more jitters (e.g., by validating at Steps 322, 328, and 334 whether the data packets respectively received at Steps 320, 326, 332include the jitters based on JCS bits JCS(0), JCS(1), JCS(2)).

As discussed in exemplary aspects, the data packet (e.g., transmitted at Steps 320, 326, 332) may be transmitted as a Bluetooth signal and the jitter may be in an inter-frame space related to the data packet (e.g., jitters based on JCS bits JCS(0), JCS(1), JCS(2)). To be detectable, the jitter is made greater than an expected uncertainty in jitter for inter-frame space (e.g., the T_IFS may have an uncertainty in range of JCS(i)*4−2, where JCS(i) may be +/−1 us to which is greater than an expected uncertainty of +/−2 us allowed in the Bluetooth specification). For instance, the first and second wireless devices may be programmed with a threshold value associated with the jitter, corresponding to the expected uncertainty of +/−2 us allowed in the Bluetooth specification, for example. The second wireless device may ensure that the jitter introduced in the two or more packets for the above-described aspects is greater than the threshold value. The first wireless device, may detect jitters which are greater than the threshold for the validating at Steps 322, 328, and 334 whether the data packets respectively received at Steps 320, 326, 332include the jitters based on JCS bits JCS(0), JCS(1), JCS(2)).

Additionally, exemplary aspects may also include an apparatus comprising means for performing exemplary functions such as the functions in method 500 of FIG. 5. An exemplary apparatus (e.g., integrated in wireless communication system 100) may comprise a first wireless device (e.g., local device 102 of FIG. 1), wherein the first wireless device comprises means for receiving a data packet (e.g., transceiver 102a) transmitted by a second wireless device (e.g., remote device 104); means for determining if the data packet includes at least a jitter (e.g., jitter management block 102e), wherein the jitter is introduced by the second wireless device based on a function of a shared key between the first wireless device and the second wireless device; and means for determining whether a relay-in-the-middle attack is present between the first wireless device and the second wireless device based at least on whether the data packet includes at least the jitter (e.g., the combination of blocks of local device 102 shown in FIG. 1, including processor 102b). In some aspects, the first wireless device may further comprise means for protecting from the relay-in-the-middle attack by withholding transmission of sensitive messages, if the relay-in-the-middle attack is determined to be present (e.g., processor 102b may provide an indication to transceiver 102a to withhold transmission of further data packets or other sensitive messages).

As discussed with reference to FIG. 2, the first wireless device can comprise means for generating a jitter cipher sequence of two or more bits from a function of the shared key, wherein the jitter is based on a first bit of the jitter cipher sequence. For example, the first wireless device (e.g., jitter management block 102e of local device 102 as shown in FIG. 2) may further comprise means for determining a jitter key from a first hash of the shared key and a salt (e.g., first hash block 202); means for determining a jitter session key from a second hash of the jitter key and a random value (e.g., second hash block 204); and means for generating the jitter cipher sequence based on an encryption of at least the jitter session key and a jitter counter (e.g., encryption block 206).

It should be noted that although FIG. 1 generally depicts a wireless communication system, the devices such as local device 102 and remote device 104 depicted therein may be integrated into a set top box, a server, a music player, a video player, an entertainment unit, a navigation device, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for detecting and protecting from a relay-in-the-middle attack in a wireless communication system. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

1. A method of operating a wireless communication system, the method comprising:
receiving, at a first wireless device, a data packet transmitted by a second wireless device;
determining, at the first wireless device, whether a jitter in the data packet matches an expected jitter, wherein the jitter is introduced by the second wireless device based on a function of a shared key between the first wireless device and the second wireless device; and
determining that a relay-in-the-middle attack is present or not present between the first wireless device and the second wireless device, respectively, if the jitter in the data packet matches or does not match the expected jitter.

2. The method of claim 1, further comprising withholding transmission of sensitive messages based on a determination that the relay-in-the-middle attack is present.

3. The method of claim 1, wherein the first wireless device is configured in a paired device model for wireless communication with the second wireless device, and wherein the shared key is established between the first wireless device and the second wireless device during a process of pairing the first wireless device and the second wireless device.

4. The method of claim 1, wherein the first wireless device is configured in an access server model for wireless communication with the second wireless device, and wherein the shared key is provisioned by an access server to the first wireless device and the second wireless device.

5. The method of claim 1, further comprising generating a jitter cipher sequence comprising the jitter and one or more additional jitters based on the function of the shared key.

6. The method of claim 5, further comprising:
determining a jitter key from a first hash of the shared key and a salt;
determining a jitter session key from a second hash of the jitter key and a random value; and
generating the jitter cipher sequence based on an encryption of at least the jitter session key and a jitter counter.

7. The method of claim 1, further comprising:
generating a jitter cipher sequence comprising the jitter and one or more additional jitters based on the function of the shared key;
determining, at the first wireless device, whether two or more data packets received from the second wireless device include two or more jitters, the two or more jitters based on two or more bits of the jitter cipher sequence; and
determining whether the relay-in-the-middle attack is present between the first wireless device and the second wireless device based further on whether the two or more data packets include the two or more jitters.

8. The method of claim 1, wherein the data packet is transmitted as a Bluetooth signal and the jitter is in an inter-frame space related to the data packet.

9. A first wireless device, comprising:
a memory;
a transceiver configured to receive a data packet transmitted by a second wireless device; and
a processor coupled to the memory and the transceiver, the processor configured to:
determine whether a jitter in the data packet matches an expected jitter, wherein the jitter is introduced by the second wireless device based on a function of a shared key between the first wireless device and the second wireless device; and
determine that a relay-in-the-middle attack is present or not present between the first wireless device and the second wireless device, respectively, if the jitter in the data packet matches or does not match the expected jitter.

10. The first wireless device of claim 9, wherein the processor is further configured to cause transmission of sensitive messages from the first wireless device to be withheld based on a determination that the relay-in-the-middle attack is present.

11. The first wireless device of claim 10, configured in a paired device model for wireless communication with the second wireless device, and wherein the shared key is established between the first wireless device and the second wireless device during a process of pairing the first wireless device and the second wireless device.

12. The first wireless device of claim 10, configured in an access server model for wireless communication with the second wireless device, and wherein the shared key is provisioned by an access server to the first wireless device and the second wireless device.

13. The first wireless device of claim 9, further comprising a jitter management block, the jitter management block comprising at least a first hash block, a second hash block and an encryption block, the jitter management block configured to generate a jitter cipher sequence comprising the jitter and one or more additional jitters based on the function of the shared key.

14. The first wireless device of claim 13, wherein:
the first hash block is configured to determine a jitter key from a first hash of the shared key and a salt;
the second hash block is configured to determine a jitter session key from a second hash of the jitter key and a random value; and
the encryption block is configured to generate the jitter cipher sequence based on an encryption of at least the jitter session key and a jitter counter.

15. The first wireless device of claim 13, wherein the processor is further configured to
determine whether two or more data packets received from the second wireless device include two or more jitters, the two or more jitters based on two or more bits of the jitter cipher sequence; and
determine whether the relay-in-the-middle attack is present between the first wireless device and the second wireless device based further on whether the two or more data packets include the two or more jitters.

16. The first wireless device of claim 9, wherein the data packet is transmitted as a Bluetooth signal and the jitter is in an inter-frame space related to the data packet.

17. The first wireless device of claim 9 integrated in a device selected from the group consisting of a set-top box, a music player, a video player, an entertainment unit, a navigation device, a personal digital assistant (PDA), a fixed location data unit, a server, a computer, a laptop, a tablet, a communications device, and a mobile phone.

18. A first wireless device comprising:
means for receiving a data packet transmitted by a second wireless device;
means for determining, at the first wireless device, whether a jitter in the data packet matches an expected jitter, wherein the jitter is introduced by the second wireless device based on a function of a shared key between the first wireless device and the second wireless device; and
means for determining that a relay-in-the-middle attack is present or not present between the first wireless device and the second wireless device, respectively, if the jitter in the data packet matches or does not match the expected jitter.

19. The first wireless device of claim 18 further comprising means for withholding transmission of sensitive messages based on a determination that the relay-in-the-middle attack is present.

20. A non-transitory computer-readable storage medium comprising code, which, when executed by a processor, causes the processor to perform operations for a wireless communication system, the non-transitory computer-readable storage medium comprising:
code for receiving, at a first wireless device, a data packet transmitted by a second wireless device;
code for determining, at the first wireless device, whether a jitter in the data packet matches an expected jitter, wherein the jitter is introduced by the second wireless device based on a function of a shared key between the first wireless device and the second wireless device; and
code for determining that a relay-in-the-middle attack is present or not present between the first wireless device and the second wireless device, respectively, if the jitter in the data packet matches or does not match the expected jitter.
